(19) United States
(12) Patent Application Publication
(10) Pub. No.: US 2006/0261130 A1
(43) Pub. Date: Nov. 23, 2006

(54) Electromagnetic driving wave soldering pot

(75) Inventor: Minghua Chai, Shenzhen (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: JT Automation Equipment Co., Ltd, Shenzhen (CN)

(21) Appl. No.: 11/204,422

(22) Filed: Aug. 16, 2005

(30) Foreign Application Priority Data
May 17, 2005 (CN) 200520019014.4

(51) Int. Cl. B23K 35/14

(52) U.S. Cl. 228/56.1

(57) ABSTRACT

The present invention discloses an electromagnetic driving wave soldering pot, includes an electromagnetic pump, a tin bath and a nozzle, and the electromagnetic pump includes an iron core, a coil group provided in the two iron core and a pump slot, the pump slot communicates with the nozzle, and the coils group includes three coils, which are supplied with three-phase alternating current excitation power supply having a phase difference of 120°. Because of the absence of any moving components and thus abrasion, the present invention not only overcomes the defects of being abrased badly and eroded easily, as well as solder being oxidized seriously in the conventional wave soldering pot, but also completely eliminates the power loss caused by the negative magnetic field in the alternating magnetic field, and effectively uses the power of the alternating magnetic field. Furthermore, because the energy consumption is decreased to 50% while the thrust and flow rate are Is increased over 2 times, this electromagnetic driving wave soldering pot can totally replace the conventional mechanical pump and meet the requirement of the practical production.

### TECHNICAL FIELD

The present invention relates to a soldering device using liquid metal solder which is employed in producing electronic products, and particularly to an electromagnetic driving wave soldering pot and a wave driving electromagnetic pump used in the soldering pot for driving liquid metal solder.

### BACKGROUND OF THE INVENTION

In the Surface Mounting Technology (SMT), especially in the soldering technologies of dual wave soldering for printed boards and single wave soldering for Surface Mounting Components (SMC), both the wave soldering technology and the wave soldering pot which use liquid solder must be employed.

Generally, most of the wave soldering machines are of mechanical pump type. Due to rotating at high temperature (about 250° C.), the blade of the mechanical pump is abraded quickly. Thus not only the solder is subject to contaminating, but also the worn blade and other components are required to be maintained and replaced periodically, resulting in inconvenience to the user. Additionally, the rotation movement of the mechanical pump causes disturbance of the surface of the tin solder, which increases the oxidation and forms lots of scruff. In order to overcome the above defects, a wave soldering pot which employs a conductive electromagnetic pump (e.g., U.S. Pat. No. 3,797,724 and CN Patent No. 8620924.2) or a unidirectional electromagnetic pump (e.g., CN Patents Nos. 93246899.3 and 91058162) are proposed subsequently. Although both may overcome the abrasion problem of the mechanical pump, the former tends to generate oxidized residue and mask electrodes, which will cause the wave to be unstable and even significantly fluctuated, while the latter form a component of the forward magnetic field by a phase difference caused by a magnetic path difference of the electromagnet, therefore the component of the magnetic field is limited and efficiency is poor.

The CN Patents Nos. 96236223.9 and 00226351.3 disclose three-phase electromagnetic pumps for a wave soldering pot. Such electromagnetic pump gets improved in efficiency as compared with the above conductive electromagnetic pump and unidirectional electromagnetic pump. However, such three-phase electromagnetic pump requires a three-phase power supply having a phase difference that is less than 90°, while the normal three-phase power supply has a phase difference of 120°. Therefore, an extra specific device is needed to obtain the three-phase power supply having the phase difference that is less than 90°. Such specific device is complicated in structure and very costly, thus it is difficult to decrease the cost of the wave soldering pot. Additionally, because the phase difference is less than 90°, the composite vector of the reverse magnetic field is not zero, such that a force for counteracting the straight thrust force that pushes the metal solder is formed. Therefore, the three-phase electromagnetic pump cannot completely eliminate the power loss caused by the reverse magnetic field, the energy of the three-phase alternating magnetic field cannot be effectively used, and the thrust and the flow rate thereof are limited. Therefore such a three-phase electromagnetic pump cannot fully replace the conventional mechanical pump in practical application, and cannot meet the requirement of real production as well.

### SUMMARY OF THE INVENTION

An object of the present invention is to provide an electromagnetic driving wave soldering pot with a electromagnetic pump that has low energy consumption and increased thrust.

To achieve the above object, the present invention provides an electromagnetic driving wave soldering pot, which includes at least an electromagnetic pump, a tin bath and a nozzle, and the each electromagnetic pump includes two iron cores, coils group provided between the two iron cores and a pump slot, wherein the pump slot communicates with the nozzle, the coils group includes three coils, and the three coils are positioned in such way that they offset from each other by ⅓ of the coil-side space of the single coil along the direction of the pump slot, and the three coils are supplied with three-phase alternating current excitation power supply having a phase difference of 120° respectively.

Preferably, axes of the three coils of the coils group are perpendicular to the pump slot.

Preferably, the iron cores on both sides of the pump slot in one electromagnetic pump are integrated, and three annular grooves are formed on the iron core to receive the three coils respectively.

Preferably, the three annular grooves are formed in the iron core on one side of the pump slot.

Preferably, the three annular grooves are formed in the iron cores on both sides of the pump slot.

Preferably, the two iron cores of the one electromagnetic pump are tightly contacted to each other and electrically and magnetically communicate with each other, and at least two of the three annular grooves are commonly provided in one of the iron cores.

Preferably, the pump slot is consisted of a straight line or a multiple-section broken line or a curve.

Preferably, the nozzle is provided at an exit of the pump slot.

Preferably, the electromagnetic pump is placed on one side of the tin bath or below the tin bath.

Preferably, the number of the electromagnetic pumps is two.

In contrast with the conventional technology, the advantages of the present invention are in that the electromagnetic driving wave soldering pot according to the present invention uses a three-phase asynchronism induced electromagnetic pump to generate a straight thrust, such that the rotation of the blade of the mechanical pump is avoided, which thus ensures a stable wave, small vibration of the liquid surface in the tin bath, and less oxide generation. Because of the absence of the rotation component, there is no abrasion, which realizes free of maintenance, and eliminates the periodical maintenance. Therefore the cost is reduced and can facilitate the user. On the other hand, the electromagnetic driving wave soldering pot according to the present invention uses common three-phase alternating voltage, that is, the phase difference of the current is 120°. Therefore, there is no need for specific device to convert the voltage, i.e. the voltage can be used directly. Furthermore, the axes of the three coils of the electromagnetic pump spaced apart for ⅓ of the coil-side space of the one coil, and the current phase difference therebetween is 120°, therefore the composite vector of the positive (i.e. the direction along the flow of the liquid metal) magnetic field force the liquid metal to move toward the nozzle along the pump slot, while the composite vector of the negative (i.e. the opposite direction relative to the flow direction of the liquid metal) magnetic field is zero, this thus completely eliminates the power loss caused by the negative magnetic field, and the power of the alternating magnetic field can be effectively used. Because the energy consumption is decreased to 50% while the thrust and flow rate are increased by over 2 times, this electromagnetic driving wave soldering pot can totally replace the conventional mechanical pump and meet the requirement of the practical production.

### BRIEF DESCRIPTION OF THE DRAWINGS

The present invention is described hereinafter in connection with the appended drawings, wherein:

FIG. 1 is a sectional illustrative view of the first preferred embodiment of the electromagnetic driving wave soldering pot according to the present invention;

FIG. 2 is a sectional view taken along the line A-A in FIG. 1;

FIG. 3 is a sectional illustrative view of the second preferred embodiment of the electromagnetic driving wave soldering pot according to the present invention; and

FIG. 4 is a sectional illustrative view of the third preferred embodiment of the electromagnetic driving wave soldering pot according to the present invention.

### DETAILED DESCRIPTION OF THE INVENTION

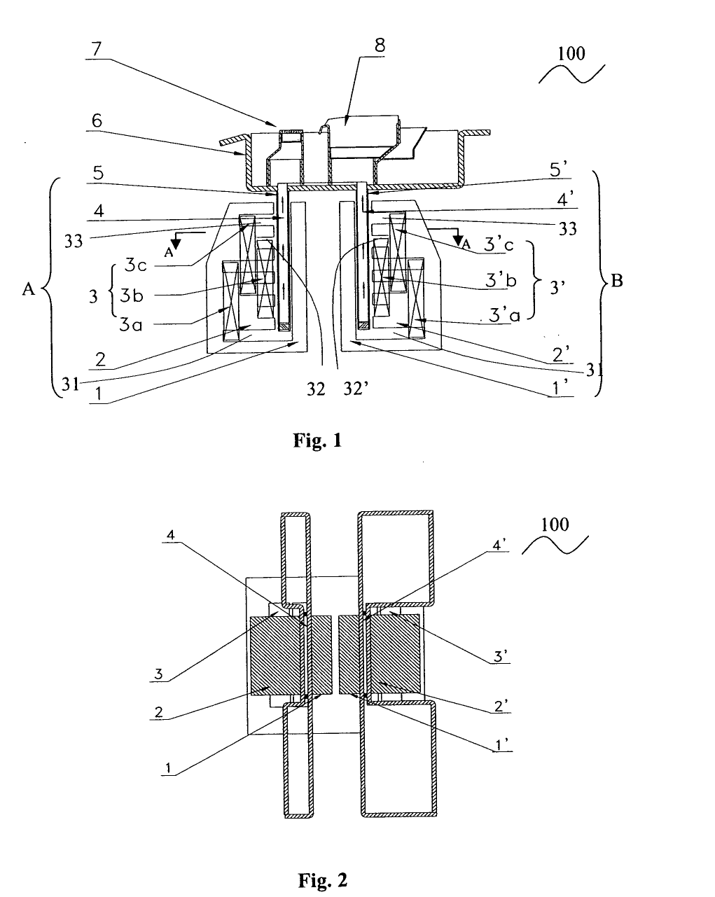

As shown in FIGS. 1 and 2, the electromagnetic driving wave soldering pot 100 according to the present invention includes a first electromagnetic pump A, a second electromagnetic pump B, a tin bath 6 and nozzles 7, 8. The first electromagnetic pump A includes iron cores 1, 2, an excitation coils group 3, and a pump slot 5. The second electromagnetic pump B includes iron cores 1′, 2′, an excitation coil group 3′ and a pump slot 5′. Since the iron cores 1, 2 and the excitation coil group 3 of the first electromagnetic pump A are substantially identical with that of the second electromagnetic pump B, the detailed description hereinafter is directed solely to the first electromagnetic pump A.

The iron cores 1, 2 may be designed as an integral, or may be separately provided. If the iron cores 1, 2 are separately provided, then the iron cores 1, 2 must reliably contact to each other to ensure the electrical and magnetical communication between the iron cores 1, 2. A plurality of annular grooves 31, 32 and 33 is provided on the iron core 1, the depth of the annular groove 31 in the lateral direction is larger than that of the annular groove 33, while the depth of the annular groove 33 in the lateral direction is larger than that of the annular groove 32. The coil group 3 includes three coils 3a, 3b and 3c arranged in the iron core 2, and the coils 3a, 3b and 3c are positioned in the annular grooves 31, 32 and 33 respectively. Moreover, the distance between the central lines of the coils 3a, 3b and 3c is ⅓ of the coil-side space (the distance between the central lines of the two coil sides) of one single coil, and the current phases of the above three coils 3a, 3b and 3c lag behind subsequently by 120°. That is to say, the current phase of the coil 3b lags behind that of the coil 3a by 120°, while the current phase of the coil 3c lags behind that of the coil 3b by 120°.

As shown in FIGS. 1 and 2, the pump slot 5 is provided between the iron cores 1 and 2. The pump slot 5 may be formed as a single straight line, or may be formed as a multiple-sections broken line or curve. The coils 3a, 3b and 3c are arbitrarily arranged in a direction perpendicularly to the pump slot 5. The first and second electromagnetic pumps A and B are provided below the tin bath 6 respectively. The iron cores 1 and 2 are connected to each other below the pump slot 5. The pump slot 5 is connected with the tin bath 6, and is inserted into the first wave nozzle 7 to communicate with the first wave nozzle 7. Liquid metal 4 enters the first wave nozzle 7 through the pump slot 5. Similarly, the pump slot 5′ is connected to the tin bath 6 and is inserted into the second wave nozzle 8 to communicate with the second wave nozzle 8. Liquid metal 4′ enters the second wave nozzle 8 through the pump slot 5′.

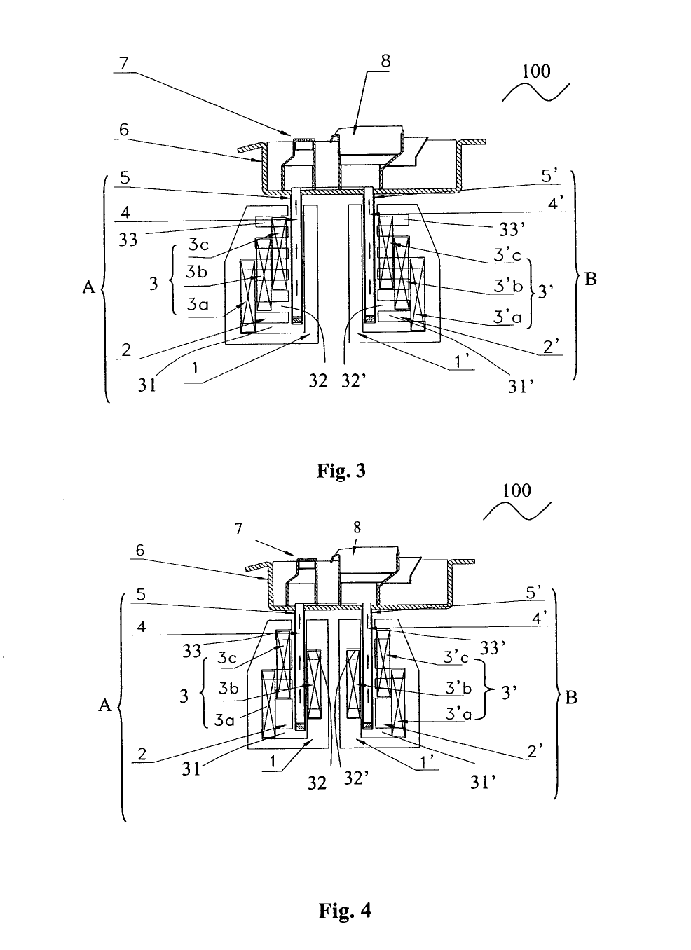

FIGS. 3 and 4 show sectional views of other two preferred embodiments of the electromagnetic driving wave soldering pot 100 according to the present invention, wherein the same number denotes the same component. The embodiment shown in FIG. 3 is different from that of FIG. 1 in that, the coil 3c of FIG. 1 is placed between the coils 3a and 3b, the central line of the coil 3a is spaced from the central line of the coil 3b by ⅓ of the coil-side space of the coil, and the central line of the coil 3b is spaced from the central line of the coil 3c by ⅓ of the coil-side space of the coil. While in the embodiment of the FIG. 3, the coil 3b is placed between the coil 3a and the coil 3c, and the central lines of the coil 3a, 3b and 3c are sequentially spaced apart by ⅓ of the coil-side space of the coil.

The embodiment shown in FIG. 4 is different from that of FIG. 1 in that, in the embodiment of the FIG. 4, a groove 32 is formed in the portion of the iron core 1 near to the pump slot 5, the coil 3b is provided in the groove 32 of the iron core 1, and thus the coils 3a and 3c are provided in the iron core 2 next to each other, while the coil 3b is provided in the iron core 1.

As shown in FIGS. 1, 3 and 4, upon operating, the coils group 3 and 3′ are supplied with standard three-phase alternating voltage, phase difference of which is 120°. The current in the coils 3a, 3b and 3c and the coils 3′a, 3′b and 3′c lag behind subsequently by phase of 120° respectively in the direction from pump slots 5 and 5′ to nozzles 7 and 8, and along a positively direction of the liquid metal flow of the pump slots 5, 5′. Additionally, the phase difference of the negative magnetic field is 120°, and the coils 3a, 3b and 3c and the coils 3′a, 3′b and 3′c are spaced apart by ⅓ of the coil-side space of the coil along the direction of the pump slots 5, 5′ respectively. Therefore, after being supplied with the current, magnetic fields in the pump slots 5, 5′ which are respectively generated by the coils 3a, 3b and 3c and the coils 3′a, 3′b and 3′c superpose to each other, and the composite vector of the negative magnetic field is zero. Therefore, the composite magnetic field thereof is completely an unidirectional traveling wave magnetic field directed from the pump slots 5, 5′ to the nozzles 7, 8, and the magnitude thereof is about 1.5 times to the magnitude of the magnetic field of one single coil, the magnetic lines of the composite magnetic field cross the pump slots 5, 5′ and then go through the iron cores 1, 1′ and iron cores 2, 2′ to form a loop. Under the action of the unidirectional traveling wave magnetic field, the conductive liquid metal flows in the direction from the pump slots 5, 5′ to the nozzles 7, 8, and the liquid metal enters from both sides of the pump slots 5, 5′, and is driven to flow toward the flow nozzles 7, 8 in the pump slots 5, 5′ and then fall down from the nozzles 7, 8. Then, the liquid metal is pumped into the pump slots 5, 5′ again, and the whole process cycles in this way.

Preferably, a electromagnetic shielding board (not shown) may be provided between the first and second electromagnetic pumps A and B to prevent the electromagnetic coupling and interfering between the first and second electromagnetic pumps A and B, and improve the efficiency of the electromagnetic pump. Additionally, the first and second electromagnetic pumps A and B may be provided not only below the tin bath 6, but also beside the tin bath 6, and the orientation of the first and second electromagnetic pumps A and B may be either parallel or perpendicular to the direction of the longitudinal axis of the nozzles 7 and 8.

In fact, the electromagnetic driving wave soldering pot 100 according to the present invention may employ only one electromagnetic pump and the corresponding pump slot and nozzle.

While the invention has been particularly shown and described with respect to a specific embodiment thereof, it should be noted that it will be understood by those skilled in the art that changes and modifications to the present invention may be made without departing from the spirit of the invention, and these changes and modifications also fall within the scope as expressed in the appended claims.

1. An electromagnetic driving wave soldering pot, which includes at least a electromagnetic pump, at least a tin bath and at least a nozzle, the each electromagnetic pump includes two iron cores, a coils group provided between the two iron cores and a pump slot, the pump slot communicates with the nozzle, wherein the coils group includes three coils, and the three coils offset from each other by ⅓ of the coil-side space of one single coil along the direction of the pump slot, and the three coils are supplied with three-phase alternating current excitation power supply having a phase difference of 120°.

2. The electromagnetic driving wave soldering pot according to claim 1, wherein axes of the three coils of the coil group are perpendicular to the pump slot.

3. The electromagnetic driving wave soldering pot according to claim 1, wherein the iron cores on both sides of the pump slot in one electromagnetic pump are integral, and three annular grooves are formed on the iron cores for receiving the three coils respectively.

4. The electromagnetic driving wave soldering pot according to claim 3, wherein the three annular grooves are formed in the iron core on one side of the pump slot.

5. The electromagnetic driving wave soldering pot according to claim 3, wherein the three annular grooves are formed in the iron cores on both sides of the pump slot.

6. The electromagnetic driving wave soldering pot according to claim 1, wherein the two iron cores of the one electromagnetic pump tightly contact to each other and electrically and magnetically communicate with each other, and at least two of the three annular grooves are commonly formed in one iron core.

7. The electromagnetic driving wave soldering pot according to any one of the claims 1-6, wherein the pump slot is consisted of a straight line or a multiple-sections broken line or a curve.

8. The electromagnetic driving wave soldering pot according to claim 7, wherein the nozzle is provided at an exit of the pump slot.

9. The electromagnetic driving wave soldering pot according to claim 7, wherein the electromagnetic pump is placed on one side of the tin bath or below the tin bath.
